(19) United States
(12) Patent Application Publication
(10) Pub. No.: US 2015/0032597 A1
(43) Pub. Date: Jan. 29, 2015

(54) ONLINE EXCHANGE FOR PERSONAL DATA

(71) Applicant: Avenace Incorporated, Seattle, WA (US)

(72) Inventors: Cameron Percy, Seattle, WA (US); Penelope Percy, Seattle, WA (US); Roger Percy, Seattle, WA (US); James Baker, Seattle, WA (US)

(21) Appl. No.: 14/451,034

(22) Filed: Aug. 4, 2014

Related U.S. Application Data
(62) Division of application No. 13/507,565, filed on Jul. 10, 2012.
(60) Provisional application No. 61/633,291, filed on Feb. 7, 2012.
(60) Provisional application No. 61/571,979, filed on Jul. 8, 2011.

(51) Int. Cl. G06F 17/30

(52) U.S. Cl. CPC G06F 17/3087; G06Q 40/04; G06F 17/30241
USPC 705/37; 707/708

(57) ABSTRACT

Technology is disclosed for an online exchange for personal data. In various embodiments, the technology receives data (e.g., geographic location data and/or personal data); determines whether the first user is to be compensated based at least on the received data; and if the first user is to be compensated, provides a compensation to the first user.

### CROSS-REFERENCE TO RELATED APPLICATION

This patent application is a divisional of U.S. patent application Ser. No. 13/507,565, filed Jul. 10, 2012, and entitled “Online Exchange for Personal Data,” and claims the benefit of U.S. Provisional Patent Application Ser. No. 61/571,979, filed on Jul. 8, 2011, and entitled “The Exchange,” and U.S. Provisional Patent Application Ser. No. 61/633,291 filed on Feb. 7, 2012, and entitled “Personal Information Exchange and Monetization Tool,” the disclosure of all applications are incorporated herein by reference in their entireties.

### BACKGROUND

People move about in the physical world, sometimes without any purposeful destination, e.g., simply for exercise, and sometimes purposefully to reach a particular location. For example, throughout a given day people commute from their homes to their workplaces or schools, they visit retail locations such as malls and restaurants, and they walk their dogs in open spaces like parks. Their motivations to reach such destinations may change with the time of day, the day of the week, the season, the weather, holidays, and many other variables. In addition, people exhibit a variety of behaviors at the locations they do frequent, for example the length of time they stay, how much money they spend there, how often they return. They also exhibit other personal preferences as they make their choices as to which locations to visit, e.g., how far they are willing to travel to get there, which types of cuisine they prefer when they choose between restaurants, how loyal they are to particular establishments.

Further, people are exposed to multiple different venues other than their ultimate destinations as they move about. Driving through a city to a restaurant, for example, a person may pass by hundreds of other possible places to eat, relax, shop, or socialize. Simply taking a different route the next time, that person could pass by hundreds more. Every location in the real world can thus be thought of as having an “audience,” made up of the people who encounter it as they move about in their daily lives. And the value of each location is informed in part by how its audience interacts with it. For example, the success of most retailers' businesses depends on whether or not people stop in to shop or eat. And the value of out-of-home media advertising displays, (e.g., billboards, subway posters, advertisements in malls), is measured according to the number and demographics of the people who have an opportunity to see them as they pass by.

“Geographic location information,” describing where individuals or population groups go as they move about in the physical world, along with the inferences that can be made about those individuals or population groups from their geographic location information, is derived from a type of “personal data”: “geographic location data.”

In the past decade, a change in how and what personal data can be and is gathered, including geographic location data, has been the result of the pervasive adoption of mobile computing devices and the dependence many people place upon them, keeping their smartphones within arm's reach throughout the day. Each of these mobile computing devices contains sensors that can collect a variety of data about the environment in which the device exists. For example, sensors in smartphones can determine the device's location and orientation, what its user is doing with the device, what networks the device is connected to, and the presence of nearby radio frequency transmitters and receivers. Furthermore, such devices can be used, among other things, to capture photographs, to make purchases, to search websites, and to elicit direct responses from their users, e.g., queries about a given user's preferences, demographics, or opinions. All of the data collected by and from someone's mobile computing device can be thought of as “personal” to that user.

There are also types of personal data that may be obtained through means other than using mobile computing devices. For example, credit card holders generate paper trails of purchase behavior, businesses track the visits and purchases of the members of their loyalty programs, credit rating agencies keep track of loans people apply for and their history of making payments, and hospitals and health insurers keep medical records on each person who uses their services. The public sector maintains extensive databases that contain data personal to individuals, from licenses they have applied for and been granted to their border crossings, their marital status, criminal histories, et cetera. Research companies survey individuals about purchase, media viewing, and voting preferences, among many other topics. Additionally, individuals are increasingly curating datasets about themselves. For example, individuals using social networking platforms, e.g., Facebook, upload many personal details about their lives.

All of this personal data—whether it is derived from mobile computing devices or not—can be of consequential use to businesses, marketers, governments, individuals, and anyone interested either in understanding how people behave currently, or in predicting how they will behave in the future. For example, automobile dealers may wish to target advertising to people who (a) live within 50 miles of their dealerships, (b) already own a car that is at least three years old and comparable in price to those they sell, (c) are from a demographic category likely to purchase a car such as those they sell, and (d) have children coming of driving age or infants about to be born. Being able to identify individuals who meet all of these criteria, combined with other behavioral personal data, would allow such automobile dealers to select out-of-home media displays sited where such potential buyers are most likely to pass, and be able to target direct mail advertisements to their residences, place advertisements on radio and television stations they frequently tune to, or target online advertisements through the websites they visit.

At present, most personal data, if it is collected at all, exists in silos that are often inaccessible either to the individuals the data is personal to, or to third parties other than those who collect it and thereafter control further access to it. Because of the private nature of most of this data, people may wish to control access to it themselves, and to share in any value that is created through its use. However, under many if not most circumstances, people believe they are required to relinquish personal data in exchange for necessary services, e.g., their home zip codes when using a credit card to purchase gasoline. It is becoming common knowledge that Internet search engines, e.g., Google, and social networks, e.g., Facebook, mine the personal data that is a byproduct of individuals' use of their sites and services to generate income from advertising targeted to those individuals. The consequent threat to individual privacy that results from the widespread collection of personal data has become a controversial and pressing topic facing consumers, businesses, policymakers, and regulators today.

### BRIEF DESCRIPTION OF THE DRAWINGS

FIGS. 1-3 are block diagrams illustrating components the disclosed technology may employ in various embodiments.

FIGS. 4-15 are flow diagrams illustrating routines invoked by the disclosed technology in various embodiments, e.g., at one or more server computing devices.

FIGS. 16A-18 are flow diagrams illustrating routine invoked by the disclosed technology in various embodiments, e.g., at one or more mobile computing devices.

### DETAILED DESCRIPTION

Technology is disclosed for collecting and employing personal data (“the disclosed technology”). Various embodiments are described herein that may operate independently or concurrently, as would be recognized by one skilled in the art.

The disclosed technology envisioned herein includes multiple inputs (variously “data”) that, when processed (e.g., subjected by the disclosed technology to aggregation, amalgamation among datasets, and algorithmic computation), produce multiple outputs (variously “information”). Inputs can include (1) data specific to individual people (“personal data”), e.g., geographic location data collected periodically or received from third party sources that describes the coordinates of the path a person takes as he/she moves about in the physical world, and (2) data that adds meaning, (e.g. contextual), to personal data (“informing dataset”), e.g., mapping data that combined with geographic location data produces geographic location information, which describes where individuals go as they move about in the physical world, along with the inferences, including demographic, that can be made about those individuals from their location information. Outputs of the disclosed technology, containing information derived from the processing of inputs from multiple individuals, third party personal data sources, and informing datasets, may be reports that may be of value to businesses, organizations, individuals, and the operator of the disclosed technology (“operator”).

Further, the disclosed technology envisioned herein may include an input of geographic location data from a third party source which may not include known or reported demographics, from which can be inferred demographic information relating to the individuals from whom the geographic location data is collected.

Further, the disclosed technology envisioned herein includes the collection of personal data from individuals resulting from the intentional participation of those individuals in exchange in part for (1) their retaining ownership of their personal data and control over third-party access to it, and (2) compensation for access that may include a bidding methodology and/or sharing of the revenue generated by the disclosed technology.

Further, the disclosed technology envisioned herein includes multiple application programming interfaces (“APIs”) designed to allow a variety of output scenarios.

Inputs to the disclosed technology are collected from multiple sources, including passively from mobile computing devices (also called “monitoring devices”) owned by and/or carried by participating individuals (“users”). For example, software installed on monitoring devices, which may include smartphones, can facilitate the periodic or constant collection of geographic location data. Although specific technologies or embodiments of location detection techniques are described herein, one skilled in the art would recognize that other technological means presently existing or developed in the future could be as easily integrated or used. Other data also may be collected directly and automatically without the user's active involvement, e.g., websites the user visits using a web browser installed on the monitoring device or other software the user may run on the monitoring device, and various parameters of the monitoring device itself, for example battery status, operating system versions, and the outputs of other sensors that may be built into a monitoring device.

Other personal data may be collected from the active inputs of users via monitoring devices or through other interfaces or mediums (e.g., a website), to supplement data types measurable through the monitoring device's sensors, e.g., queries to determine a user's demographics or consumer and/or brand preferences, queries to determine other behavioral traits and preferences. Users may create individual accounts, authenticated with account credentials, (e.g., email address and password). Further, users may log in and log out using their account credentials. If the user logs out, the monitoring device may suspend collection of geographic location data. Queries that require input from users may be triggered at any time by the software in the monitoring devices, including at times when the user is in a location or exhibiting a behavior relevant to the content of the query. Further, such queries may be triggered by the central server. New query content may be transmitted to monitoring devices remotely. Also, users may be prompted to upload other data they collect describing non-electronic content, e.g., photographs, QR or other visual “bar” codes.

Data collected via the monitoring device may be stored locally in the monitoring device's memory and uploaded to a central server at a later time, or uploaded in real time to a central server. Uploading of collected data may be initiated by the user, by the central server, or periodically automatically by the monitoring device's software.

Some behaviors of the monitoring device may be controlled remotely by a central server. For example, the monitoring device may be set to collect geographic location data during only some hours of each day and/or on some days, to collect geographic location data with variable regularity, to attempt collection of geographic location data for a variable duration of time each instance its collection is initiated, to upload collected geographic location data to a central server on a desired schedule or when desired conditions exist, (e.g., when the monitoring device is plugged into a power supply and/or is connected to a Wi-Fi network), and to change behavior when one or more settable levels of battery status are encountered. Changes to the settings for device behavior may be pushed to each device or may be synced at the time that the device uploads collected data to the server.

Behaviors of the monitoring device may be implemented in order to conserve the available battery power on the device. For example, the frequency at which the device collects geographic location data may be changed in accordance with the existence of determined conditions, (e.g., when the device is connected to a Wi-Fi network or other radio frequency system, the speed at which the device is traveling, the physical environment surrounding the device, and/or if previous attempts to collect geographic location data have succeeded or failed). Further, the periods of time during which the monitoring device collects geographic location data may be limited and varied in order to conserve available battery power and capture the location-dependent behaviors of users on a longitudinal (or extended) basis.

Behaviors of the monitoring device may be implemented in order to minimize data transmitted to the central server via radio frequency methods, (e.g., cellular data network). For example, the monitoring device may be set to upload collected data only when connected to a Wi-Fi network, or to delay the uploading of such data for a set duration of time waiting for a possible connection to a Wi-Fi network.

Techniques may be used by the monitoring device and/or by the central server to minimize and/or optimize the collected data. For example, data compression methods may be implemented, and algorithms may be employed to discard or archive redundant (or practically redundant) collected data.

Additional inputs to the disclosed technology may take the form of personal data that describes individual participants, but that will not necessarily be collected from monitoring devices. Such data may be obtained with or without the user's direct participation. For example, the disclosed technology may import datasets of users' shopping and other financial data (e.g., investment statements, credit card transactions), users' web browsing and computing activity and history, users' social interactions (e.g., social networking, gaming, e-mail, phone), users' membership in loyalty programs and/or other clubs, users' exposure to all forms of media and advertising (e.g., magazines, television, radio), and users' travel activity (e.g., vacations, business travel, air travel).

Personal data inputs collected and stored in the disclosed technology are analyzed in a variety of ways in order to produce the outputted reports. The disclosed technology may provide three primary levels of analysis: the individual level, the group level, and the population level. At the individual level, the disclosed technology may simply produce reports summarizing the behaviors or traits of a given individual user. Collected personal data may be partially anonymized by removing or abstracting tags that identify the user to whom the data pertains. At the group level, the disclosed technology may produce reports summarizing the behaviors or traits of groups of users through an aggregation of the individual data, thereby further anonymizing the personal data incorporated in the report. And at the population level, the disclosed technology may use additional inputs, (e.g., U. S. Census data), to project the observed behaviors and traits of users to the population at large or to specific sub-populations (e.g., all those who live in a given neighborhood, or all those who shop at a particular store chain). Such projection is the final step in transforming personal data inputs from “personally identifiable as” to “impersonally characteristic of.” Additionally, demographic and behavioral traits may be inferred from personal data. For example, an individual user's music preferences may be inferred from his/her attendance at concerts or other events, or an individual user's income may be inferred from his/her hobbies or membership in clubs.

Informing database inputs, (e.g., U.S. Census data, as above), are amalgamated with personal data inputs and with each other to add actionable meaning for report outputs. For example, individual geographic location data, combined with map-matching and purchase behavior databases, and projected to the local community population, could help predict the likelihood of success for a new, high-end, specialty retail store in that community. The value of a geographic location is informed in part by how its audience interacts with it. For example, the success of most retailers' businesses depends on whether or not people stop in to shop or eat. And the value of out-of-home media advertising displays, (e.g., billboards, subway posters, advertisements in malls), is measured according to the number and demographics of the people who have an opportunity to see them as they pass by. The disclosed technology enables prediction of such transit patterns and audience exposure.

A type of analysis that may be performed at all three levels quantifies traits or behaviors. For example, the disclosed technology may measure the frequency that individuals, groups, or populations drive past a particular billboard, or eat at a particular restaurant.

A further type of analysis that may be performed at all three levels may identify and quantify correlations between the behaviors and traits of individuals, groups, or populations. For example, the disclosed technology may quantify the relationship (or interdependence) between shopping at a particular store chain and owning a particular brand of car.

A further type of analysis that may be performed at all three levels may predict the likelihood of observing a given (observable or unobservable) behavior or trait depending on other known variables. For example, the disclosed technology may predict how a sub-population of people may react to an advertising campaign given their exposure to advertisements, their demographics, their previous purchasing behavior, their location information, and their proximity to the advertiser's stores.

The disclosed technology may also categorize users according to their behaviors and traits. For example, the disclosed technology may create an A, B, C, et cetera grading system to label individual users on a spectrum from heavy commuters to stay-at-home workers or parents. A further example may feature A, B, C, et cetera grades to categorize users on a spectrum of high-end shoppers to bargain hunters. Such a feature may be included in reports to simplify and summarize the behaviors and traits of individuals, groups, and sub-populations.

As an example of these several types of analyses, collected geographic location data for a given user can be processed to determine if the user is ever located inside or transits through a delineated geographic zone (an “impact zone”). Impact zones may be defined using electronic mapping systems, e.g., geographic information systems, or other publicly available solutions, e.g., Google Maps. As part of a disclosed technology report output, impact zones may take the form of a polygon of any size and shape, and may be defined to correspond to geographic areas of particular interest to the recipient of the report. For example, an advertiser may wish to determine how many users, between the ages of 25 and 45, pass through the visible area of an out-of-home media display. To provide the requested report output of transit counts, the geographic location data of multiple users with appropriate demographics are map-matched for transit accuracy and then correlated with the coordinates of the advertiser's designated impact zone, as drawn using the disclosed technology's web-based tools and format.

Further analysis that may be accomplished on identified user transits through a specified impact zone, incorporating multiple inputs, include determining, for example, the speed at and direction in which the user moves through the impact zone, the duration of time the user spends inside the impact zone, (“dwell time”), the time of day, day of week, season, et cetera when the user transits the impact zone, the mode of transit (or transportation) the user employs to pass through the impact zone, (e.g., walking, driving, cycling, et cetera), the frequency with which the user has transited the impact zone during a defined period of time, and the average distance the user covers on any given trip before and/or after transiting a given impact zone. Another analysis may include determining how many users transit through a given impact zone who have also displayed one or more observable characteristics, for example shopping at a particular store.

Further, besides counting and analyzing user transits through impact zones, and in combination with other known characteristics of the population at large, user transits through impact zones may be projected to infer the population's movements through such an impact zone. There may be many considerations involved in creating such an inference, for example the demographics and travel patterns of users may be adjusted (e.g., weighted) in order to improve the accuracy and generality of such an inference. The final results of this process may include reports on the reach, frequency, and demographics of the population's exposure to any given impact zone. Besides the general population, the impact zone transits of subsets of the population, defined by their characteristics or behaviors, may also be projected and quantified. For example, a subset of the population may consist of female shoppers who patronize a particular department store, and a projected and weighted impact zone report may provide an estimate of the subset's transits through the visible area of that department store's out-of-home media displays, as compared to other subsets of the population.

Multiple impact zones may also be considered and evaluated to yield a variety of analyses. For example, impact zones may be combined to determine aggregate user transits, (e.g., for audience measurement of an out-of-home media campaign), or the correlation of user transits through two or more given impact zones, (e.g., to determine if exposure to an out-of-home media display influences user choice as to where to shop, or which competing stores users may visit).

Further statistics may be calculated on collected user geographic location data, once it has been combined with informing dataset inputs. For example, tabulations may be made for a specified time period on the distance users travel, the distance covered and time spent using various modes of transportation, and the distance covered between destinations.

Among other options, the results of each analysis of impact zones and projections to a population may be conveyed in textual descriptions, graphical depictions (e.g., bar graphs), and matrices (e.g., spreadsheets) and in electronic or print format.

Aspects of technology for measuring the effectiveness of advertising or other media displays for various intended purposes are disclosed in U.S. Pat. Nos. 6,970,131; 7,038,619; 7,176,834; 7,215,280; 7,408,502; and 7,586,439; and in U.S. Patent Pub. No. 2009-0073035, the disclosures of which are incorporated herein in their entireties by reference.

Traditional personal data acquirers have included research companies, (e.g. Nielson Company), and Internet and mobile platforms, (e.g. Google, Facebook). These entities' methodology has been to pay individuals, (e.g., in cash, prizes, or services), to participate as research panel members or to accept advertising targeted at them, with the entity exercising ownership of the personal data once it is acquired and then using it itself or selling/providing it for a specific purpose and/or to a specific client base. In contrast, the disclosed technology envisioned herein may allow the ownership of personal data collected over users' mobile devices to reside with the users. Analyses may be performed on the collected data in accordance with the needs of the end consumers of reports generated by the disclosed technology (“clients”), as defined by the clients, and the clients themselves may use the processed information for a variety of purposes and in a variety of contexts. Users may make choices about the ways in which their individual data may be incorporated in reports and the clients who may access those reports in exchange for a form of compensation. Users may also delete their data from the operator's collected database, and/or terminate their accounts.

The disclosed technology may offer users relationships (“partnerships”) with clients, through which clients gain the right to include consenting users' processed information in the reports that the disclosed technology generates on their behalf. For such partnerships, clients may be identified to users individually, either by name or by function category, (e.g. car dealership, fast food restaurant), or included in groups that share some common trait. For example, users may be offered two “big box” retailers with which to form separate partnerships, or may be offered a single partnership with a group of such retailers. In another example, a user may choose to select one client or group of clients and not another, e.g., the user may agree to having his/her data used in a report processed for a local coffee shop but not for a chain coffee company. Different clients may or may not be aware of each other's status as clients, e.g., two “big box” retailers may be competitors and may not know that the other is a client.

Users indicate their preferences and consent for partnerships through software on their monitoring devices or through a website where they log in with their individual account credentials. Available partnerships are presented to each user, and may include information such as the types of reports to be generated for the client or group of clients, and the way such reports will be used.

Users may be compensated by clients for their participation in partnerships, and/or may be compensated by the operator of the disclosed technology for their initial registration and participation prior to joining partnerships. The operator of the disclosed technology may act as a client, and compensate users accordingly. The operator of the disclosed technology may earn revenue by taking a derivative share of compensation paid to users. Compensation to users may take the form, among others, of direct monetary payments or similar instruments (e.g., gift cards), contributions to nonprofit organizations, functionality created by the operator of the disclosed technology or third parties, (e.g. a travel diary app), event or entertainment opportunities, (e.g., a food cart lunch for users whose work is located nearby, tickets for a sports event where users sit together), games with prizes, (e.g. an impact zone game awarding a daily prize for the user transiting a predesignated but unidentified impact zone at a randomly picked time of day), or securities offered by the operator of the disclosed technology, (e.g., shares of stock or stock options), that may represent a pro rata portion of ownership in the entity operating of the disclosed technology, the value of which may change over time.

Different users may have different values for clients, depending on a variety of parameters. For example, a clothing retailer that targets consumers from young demographics may desire to have only the participation of those types of users in a partnership. Additionally, users with defined traits may be more plentiful than users with other traits. For example, younger users may ultimately register to participate in larger numbers than older users, who thereby gain in value due to scarcity. Accordingly, when users are offered choices of partnerships, they may see different levels of compensation “bid” for their participation.

Further, bids for users' participation in partnerships may also vary depending on where geographically such users live, work, or otherwise spend time. For example, users who live in dense urban areas may be more plentiful than users living in outlying suburban areas, and therefore the suburban users may be offered higher bids to form partnerships. An additional variation in bid price may be determined by one or more behavioral traits some users exhibit. For example, one “big box” retailer may wish to include information in its reports on users who shop at a competitor's stores. Therefore, those users may see higher bids from such a client for their participation in a partnership.

Another aspect is that a given client may in fact provide reports to multiple sub-clients. For example, Company X may sponsor a partnership on behalf of multiple independent real estate brokers, each of which would otherwise have to bid for partnerships separately.

Another aspect is that disclosed technology output information may be used to develop a trading strategy for securities or other assets. For example, before similar information is available in the public market, analyses performed by the disclosed technology may quantify how consumers respond to changes in gas prices, or if a fast food chain's store traffic is beating or missing expectations. Further, the operator of the disclosed technology may acquire valuable iintelligence by knowing what party is accessing information through the disclosed technology and what queries it is performing.

The disclosed technology may include a website that, for example, allows users to customize their experience with the disclosed technology, (e.g., define demographics, participate in a forum), and obtain information about the disclosed technology, (e.g. updated Privacy Policy or FAQ statements, the nonprofits receiving contributions).

The disclosed technology may include a series of APIs to enable clients to query collected inputs, (e.g. request an impact zone analysis), as permitted through their partnerships. The APIs may allow clients to query collected inputs from a subset of consenting users determined by their demographic or behavioral characteristics. For example, a client may initiate a call through an API to generate a report on how often male users over thirty years old visit the client's retail outlets. Multiple APIs may be incorporated into the disclosed technology to produce different types of report outputs. For example, another API may allow clients to request a report that is not specific to a given impact zone, but which graphically depicts concentrations of users (or the inferred population) depending on defined demographic or behavioral traits, (e.g., a report could be produced by an API that shows a graphical “heat map” of where 30-45 year old white males are concentrated in a city at a given time of day, or where concentrations of sports bar patrons are at a given time of day).

Another API may permit users to review processed information.

Another API may permit third parties to create products and services intended for use by the users themselves, that take advantage of the collected inputs. For example, a third party software developer may create an application to identify promotions and “daily deals” that are convenient for any given user based on his/her typical travel patterns. Further, such an API may be used by third parties to create products and services for the disclosed technology's operator's and their own clients.

Another API may permit the operator of the disclosed technology or third parties to target advertisements that are location and/or behaviorally relevant to users and populations and to clients.

The disclosed technology may include a website that allows clients to design, customize, (e.g., define impact zones, define populations of interest), and obtain reports, create partnerships, bid for users' information, and pay the operator of the disclosed technology.

Several embodiments of the disclosed technology are described in more detail in reference to the Figures. The computing devices on which the disclosed technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that may store instructions that implement at least portions of the disclosed technology. In addition, the data structures and message structures may be stored or transmitted via a data transmission medium, such as a signal on a communications link. Various communications links may be used, such as the Internet, a local area network, a wide area network, or a point-to-point dial-up connection.

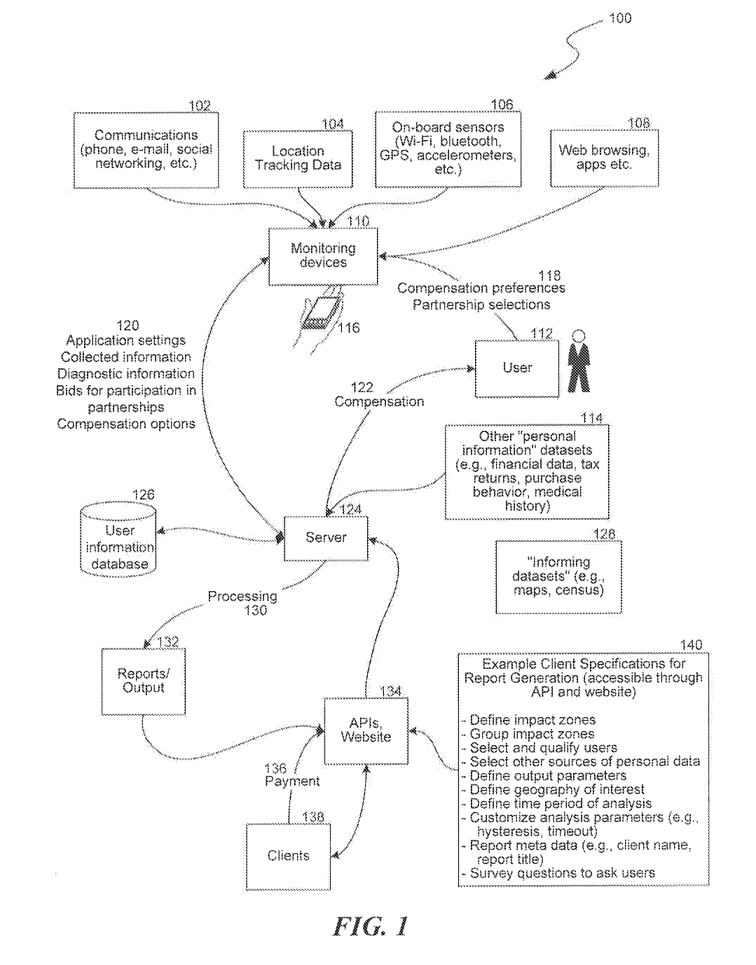

FIGS. 1-3 are block diagrams illustrating components the disclosed technology may employ in various embodiments. Referring now to FIG. 1, an illustration of the disclosed technology, “System Ecosystem,” 100 includes a communications component 102, geographic location data 104, sensors 106, applications 108, etc. These components may be employed in conjunction with a monitoring device 110, e.g., a mobile computing device 116. Examples of mobile computing devices are smart phones, tablet computers, personal digital assistants, etc. The monitoring device 110 can receive compensation preferences, partnership selections, or other data 118 from a user 112. Examples of compensation preferences can include, e.g., deposit to a bank account or via an electronic payment option, bids for participation in partnerships, etc. The disclosed technology may exchange data with a server computing device 124. As an example, the disclosed technology may transmit partnership selections from a monitoring device 110 to the server 124, and thereafter transmit compensation information from the server 124 to the monitoring device 110. The server 124 may also transmit various other information 120 to the monitoring device 110, e.g., application settings, collected data, diagnostic information, bids for participation in partnerships, compensation options, etc. The server 124 may store data exchanges with the monitoring devices 110 in a user information database 126. The server 124 may also receive other personal data 114 relating to users, e.g., data sets relating to financial data, purchasing behavior, etc., and store this data in the user information database 126. The server 124 may also receive other data sets, e.g., publicly available data 128. Examples of publicly available data can include, e.g., maps, census data, etc. The server 124 may include logic for processing 130 the data it is capable of receiving or storing and producing reports or other output 132. The server 124 may also provide APIs, web sites, reports, etc. 134. Examples of APIs are identified in block 140. The server 124 may also interact with clients 138, e.g., to receive requests, provide reports, receive payments 136, etc.

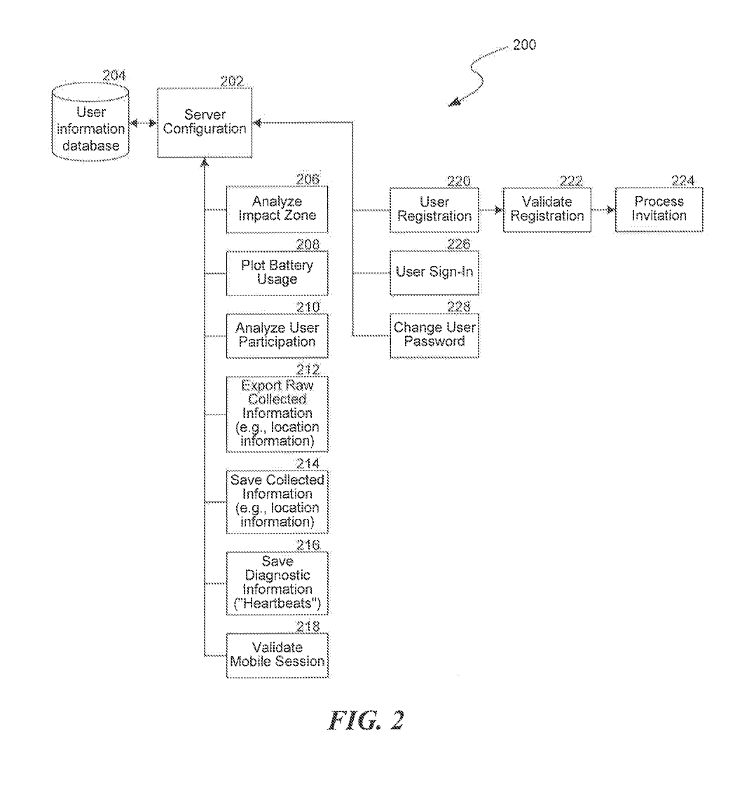

As illustrated in FIG. 2, a server environment 200 having a server configuration 202 can include a database 204 and multiple components 206-228. The multiple components 206-228 can provide various logic associated with server-side processing. Examples can include, e.g., analyzing impact zones 206, plotting battery usage 208, analyzing user participation 210, exporting raw collected data 212, saving collected data 214, saving diagnostic information 216, validating mobile sessions 218, user registration 220, validating registrations 222, processing invitations 224, sign in 226, and password management 228.

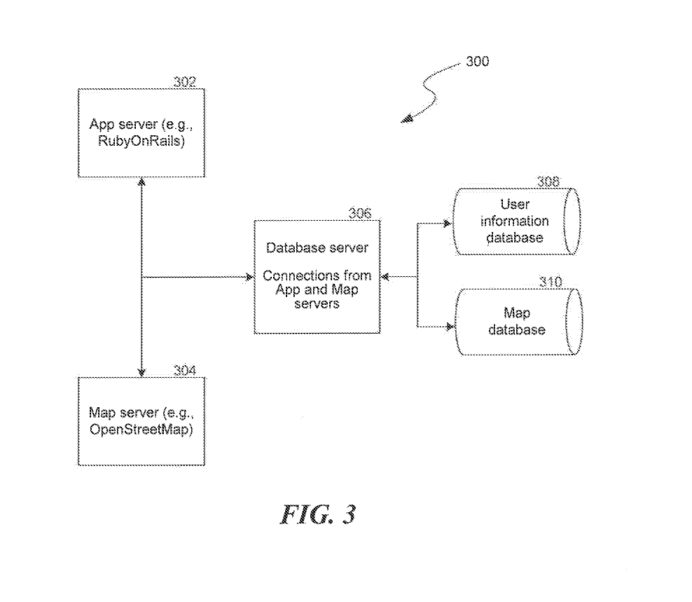

As illustrated in FIG. 3, a server configuration 300 can include an application server 302, a map server 304, and a database server 306 having a user information database 308 and a map database 310.

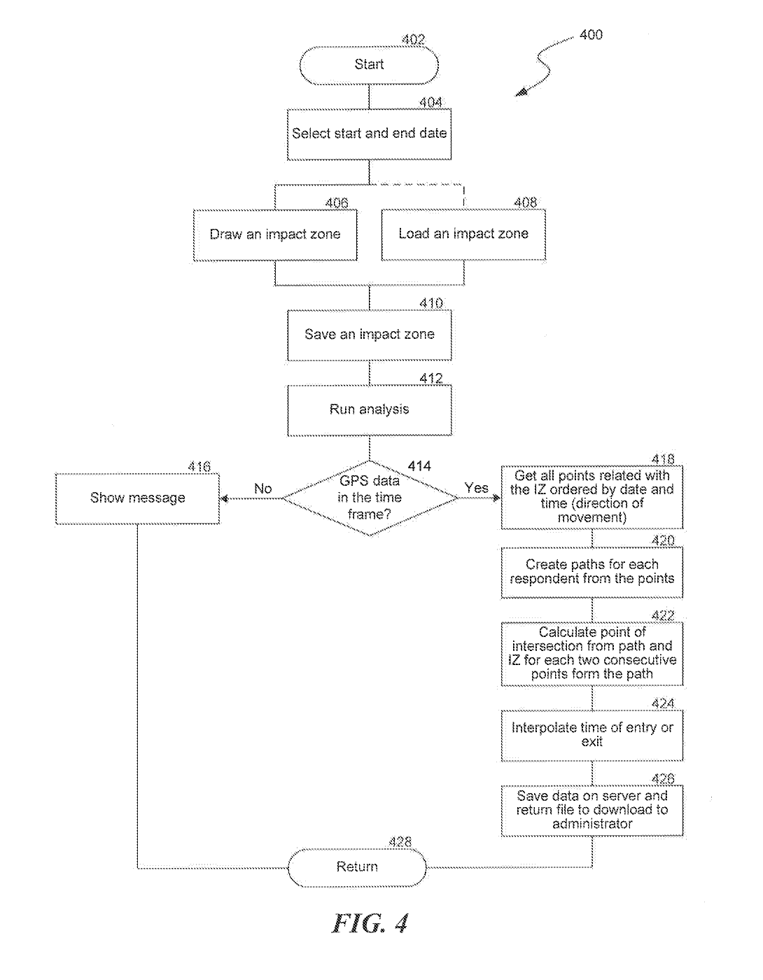

FIGS. 4-15 are flow diagrams illustrating routines invoked by the disclosed technology in various embodiments, e.g., at one or more server computing devices.

FIG. 4 is a flow diagram illustrating a routine 400 for analyzing an impact zone (IZ). The routine 400 begins at block 402. At block 404, the routine selects a start and an end date for the analysis. The routine can either receive a user's input to draw an impact zone 406 or load a previously existing impact zone 408. In either case, the routine continues at block 410, where it saves the impact zone 410 for further analysis. At block 412, the routine runs an analysis to produce a report. The routine then continues at decision block 414, where it determines whether the system has GPS data for the duration specified at block 404. If it has GPS data, the routine continues at block 418. Otherwise, the routine continues at block 416 where it displays a message to the user and then returns at block 428. At block 418, the routine retrieves all points related to the impact zone and orders it by date and time. By doing so, the routine is able to detect the direction of movement of users who provided geographic location data. The routine then continues at block 420, where it creates paths for each user (“respondent”) based on the stored GPS points. The routine then continues at block 422, where it computes a point of intersection from the path and the impact zone for each two consecutive points from the path. The routine then continues at block 424, where it interpolates the times of entry or exit, e.g., for each two consecutive points. The routine then continues at block 426, where it saves the computed and interpolated data, and provides a file that can be downloaded. The routine then returns at block 428.

Those skilled in the art will appreciate that the logic illustrated in FIG. 4 and described above, and in each of the flow diagrams discussed below, may be altered in a variety of ways. For example, the order of the logic may be rearranged, substeps may be performed in parallel, illustrated logic may be omitted, other logic may be included, etc.

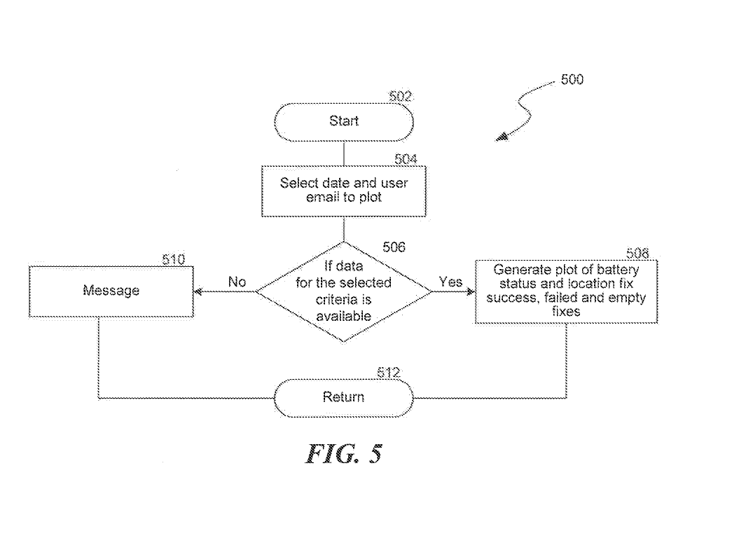

FIG. 5 is a flow diagram illustrating a routine 500 for plotting battery usage. The routine 500 begins at block 502. At block 504, the routine selects a date and a respondent's identifier (e.g., e-mail address) to plot. The routine then continues at decision block 506, where it determines if data for the selected criteria is available. If data is available, the routine continues at block 508. Otherwise, the routine continues at block 510. At block 508, the routine generates a plot of battery status and geographic location fix success, failed, and empty fixes. The routine then returns at block 512. At block 510, the routine provides a message and then returns at block 512. In various embodiments, the disclosed technology may employ the routine 500 to determine what effect the disclosed technology is having on a user's mobile computing device battery.

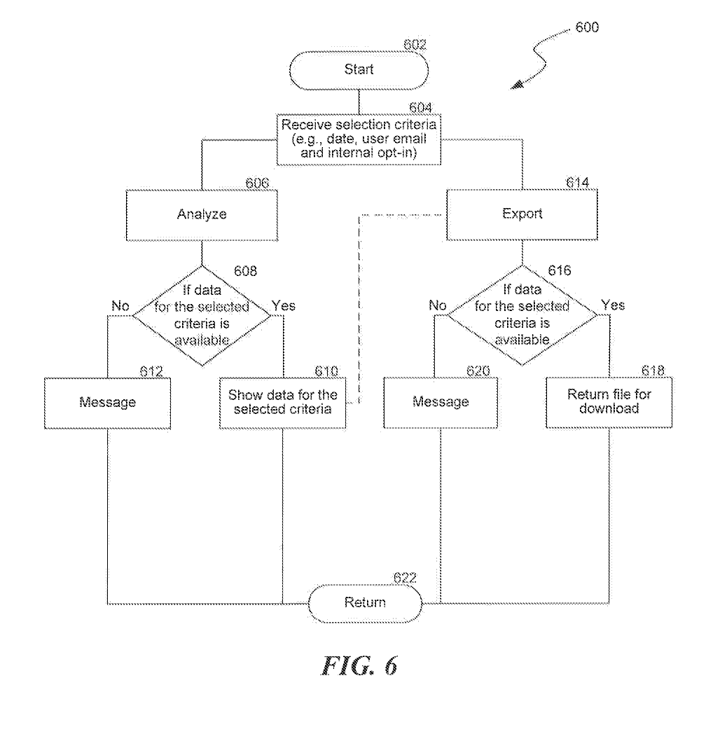

FIG. 6 is a flow diagram illustrating a routine 600 for analyzing user participation. The routine 600 begins at block 602. At block 604, the routine receives selection criteria and other options. If an option to analyze user participation is selected, the routine continues at block 606. Otherwise, if an option to export the analysis is selected, the routine continues at block 614. At block 606, the routine begins the analysis. The routine continues at decision block 608, where it determines whether data for the criteria specified at block 604 is available. If data is available, the routine continues at block 610. Otherwise, the routine continues at block 612. At block 610, the routine displays the data for the selected criteria. The routine then returns at block 622. At block 612, the routine displays a message and then returns at block 622. After completing the logic of block 610, the routine may optionally continue at block 614, e.g., if the user decides to also export the analysis. The routine then continues at decision block 616, where it determines if data is available for the criteria specified at block 604. If the data is available, the routine continues at block 618. Otherwise, the routine continues at block 620. At block 618, the routine prepares then returns a file for download. The routine then returns at block 622. At block 620, the routine displays the message to the user and then returns at block 622.

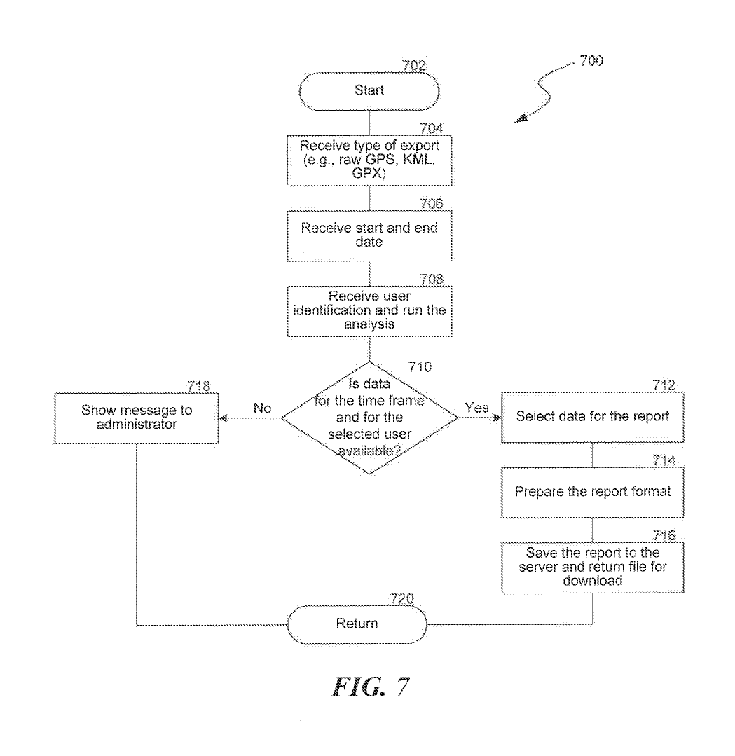

FIG. 7 is a flow diagram illustrating a routine 700 for exporting collected data. The routine 700 beings at block 702. At block 704, the routine receives the desired format for the exported data (e.g., a comma delimited file, KML, or GPX). At block 706 the routine receives the start and end dates of the data to be exported. At block 708, the routine receives the identity (or identities) of users whose data is to be included in the exported file. The routine continues at block 710, where it determines if data is available to be exported according to the given parameters. If such data is available, the routine continues at block 712, where the routine selects the desired data from the database. The routine continues at block 714, where it prepares the file in the desired format for export. At block 716 the routine saves the file to the server and provides it for download and then returns at block 720. If after block 710 no data is available for export, the routine shows a message to the administrator at block 718 and returns at block 720.

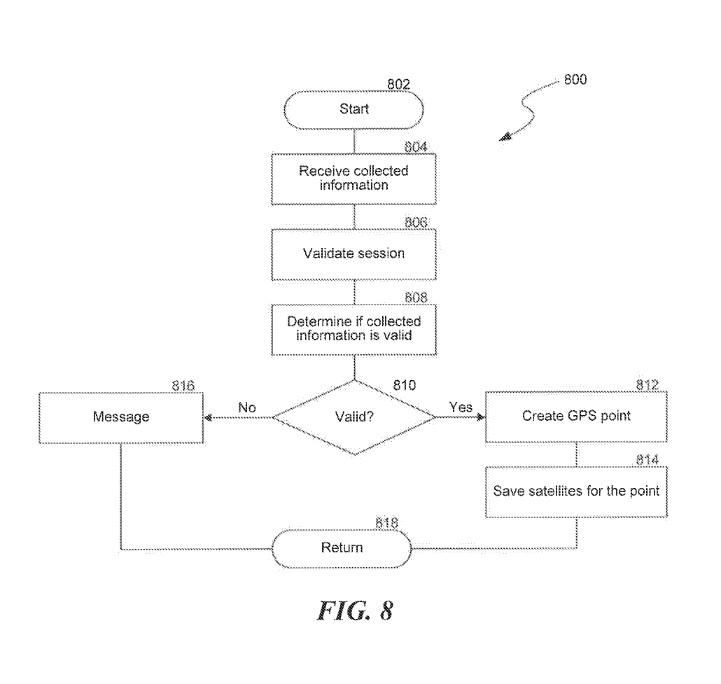

FIG. 8 is a flow diagram illustrating a routine 800 for saving collected data. The routine begins at block 802. At block 804 the server receives collected data. At block 806, the routine validates the session of the source providing the collected data. At block 808, the routine determines if the collected data is valid. If at block 810 the data is determined to be valid, the routine proceeds to block 812 where it creates a record for to store a GPS point. At block 814, the routine saves the identification numbers and carrier-to-noise ratios of the satellites used to compute each given GPS point, and the routine returns at block 818. If at block 810 the data is found not to be valid, the routine displays a message at block 816 and returns at block 818.

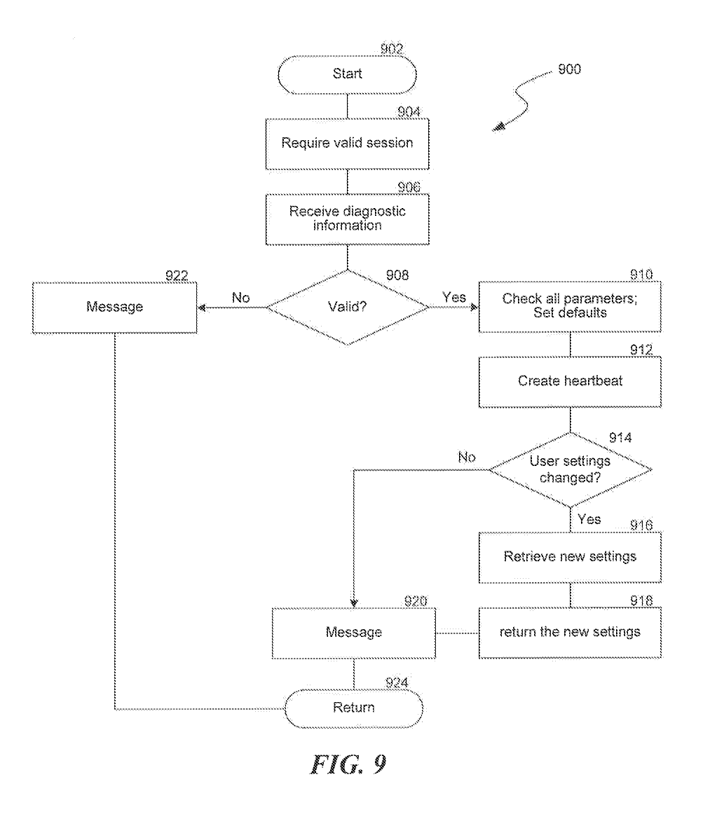

FIG. 9 is a flow diagram illustrating a routine 900 for saving diagnostic information (for example “heartbeats”) transmitted to the server by the monitoring devices. The routine begins at block 902. At block 904 the routine validates the session of the device transmitting the information. At block 906 the routine receives the diagnostic information. At the block 908 the information is checked for validity. If it is found to be valid, the routine continues to block 910 where all parameters are checked and default values are retrieved from the database if they are missing from the received information. At block 912 the routine creates a record for the received information (e.g., a “heartbeat”). At block 914 the routine checks to see if the application settings have been changed. If yes, the routine continues to block 916 where the new settings are retrieved from the database and transmitted to the monitoring device at block 916. At block 920 the routine displays a message and returns at block 924. If at block 914 the routine determines that the application settings have not changed, the routine displays a message at block 920 and returns at block 924. If at block 908 the routine determines that the received information is not valid, a message is displayed at block 922 and the routine returns at block 924.

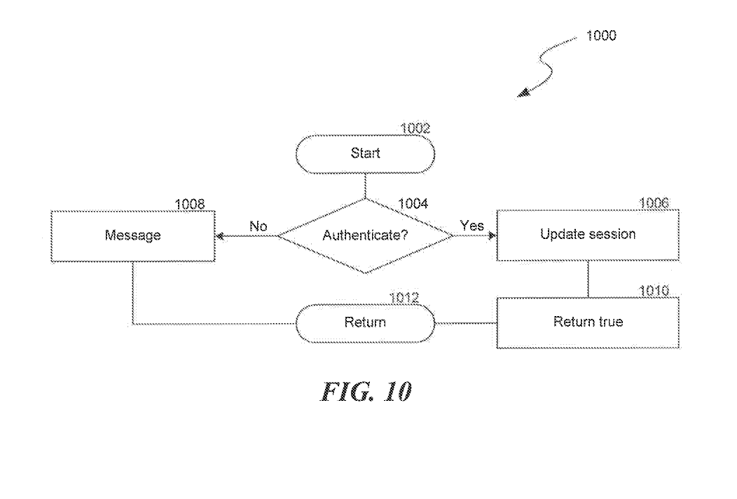

FIG. 10 is a flow diagram illustrating a routine 1000 for validating the session of a monitoring device. The routine begins at block 1002. At block 1004 the routine checks to see if the monitoring device is properly authenticated. If it is, the routine continues at block 1006 where its session is updated. The routine then returns true at block 1010 and returns at block 1012. If at block 1004 the monitoring device is not properly authenticated, the routine produces a message at block 1008 and then returns at block 1012.

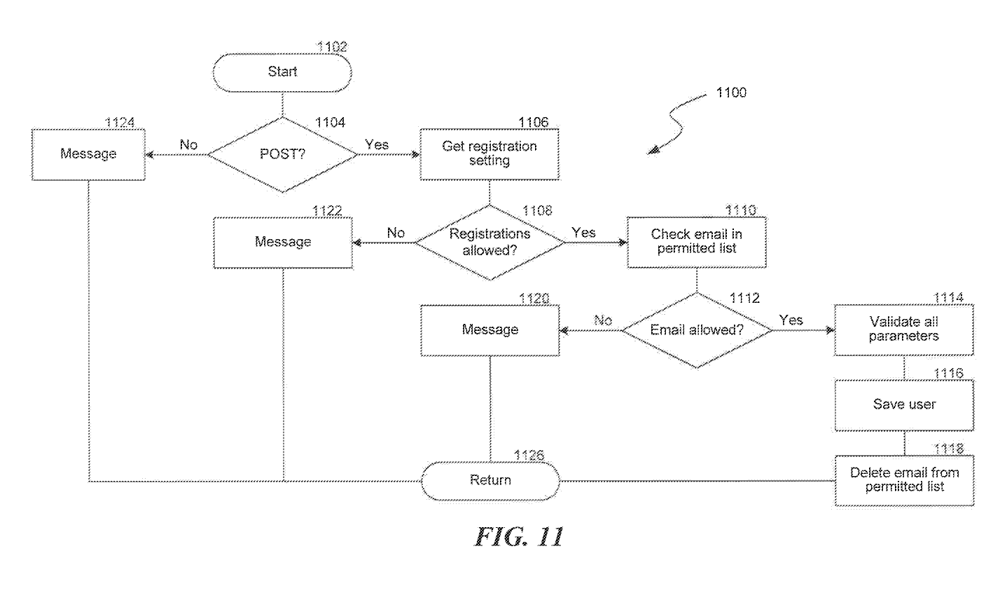

FIG. 11 is a flow diagram illustrating a routine 1100 for user registration. The routine begins at block 1102. At block 1104 the monitoring device posts to the server. If no post is received, the routine produces a message at block 1124 and returns at block 1126. If a post is received, the routine continues at block 1106 where the server gets the current settings regarding user registration. At block 1108 the routine checks if registrations are currently allowed. If they are not, the routine produces a message at block 1122 and returns at block 1126. If registrations are currently allowed, the routine checks to see if the registering user's e-mail address is in the list of permitted e-mail addresses at block 1110. Next, if at block 1112 the routine determines that the registering user's e-mail address is not in the list of permitted e-mail addresses, the routine produces a message at block 1120 and returns at block 1126. If at block 1112 the routine determines that the registering user's e-mail address is in the list of permitted e-mail addresses, the routine continues at block 1114 where all parameters for the registering user are validated. The routine continues at block 1116 where the new user record is saved. Then, at block 1118 the new user's e-mail address is deleted from the list of permitted e-mail addresses and the routine returns at block 1126.

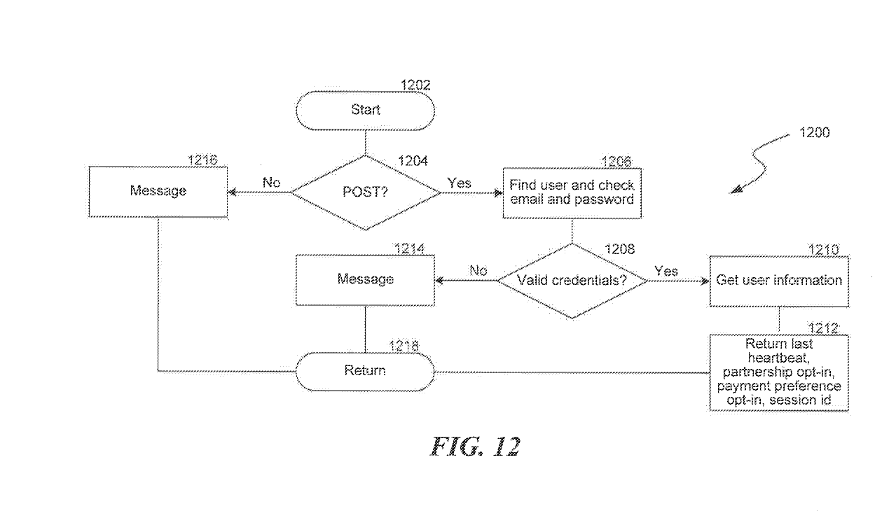

FIG. 12 is a flow diagram illustrating a routine 1200 for user sign-in. The routine begins at block 1202. At block 1204 the monitoring device posts the account credentials inputted by the user to the server. If no post is received, the routine produces a message at block 1216 and the routine returns at block 1218. If a post is received, the routine continues at block 1206 where the routine finds the user's account credentials (e.g., e-mail address and password). At block 1208 the routine determines if the inputted credentials received at block 1204 are valid. If the credentials are not valid, the routine produces a message at block 1214 and returns at block 1218. If the credentials are valid, the routine continues at block 1210 where it gets information on the user's account. At block 1212 such information is returned (e.g., the last heartbeat received, the status of partnership opt-ins, payment preferences, session ID). The routine returns at block 1218.

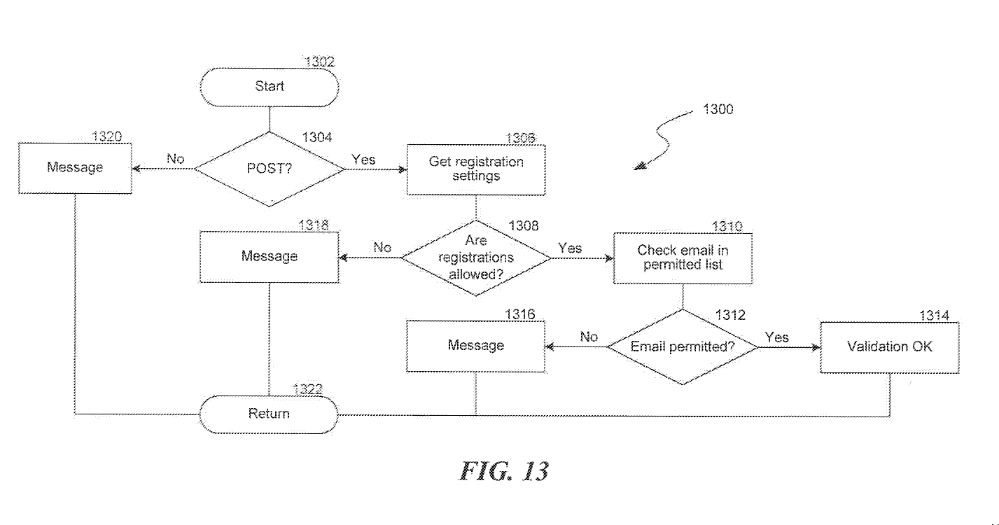

FIG. 13 is a flow diagram illustrating a routine 1300 for validating user e-mail addresses. The routine begins at block 1302. At block 1304 the monitoring device posts to the server. If no post is received, the routine produces a message at block 1320 and returns at block 1322. If a post is received, the routine continues at block 1306 where the server gets the current settings regarding user registration. At block 1308 the routine checks if registrations are currently allowed. If they are not, the routine produces a message at block 1318 and returns at block 1322. If registrations are currently allowed, the routine checks to see if the registering user's e-mail address is in the list of permitted e-mail addresses at block 1310. If the routine determines at block 1312 that the registering user's e-mail address is not in the list of permitted e-mail addresses, the routine produces a message at block 1316 and returns at block 1322. If at block 1312 the routine determines that the registering user's e-mail address is in the list of permitted e-mail addresses, the routine continues at block 1314 where it concludes the validation is acceptable and the routine returns at block 1126.

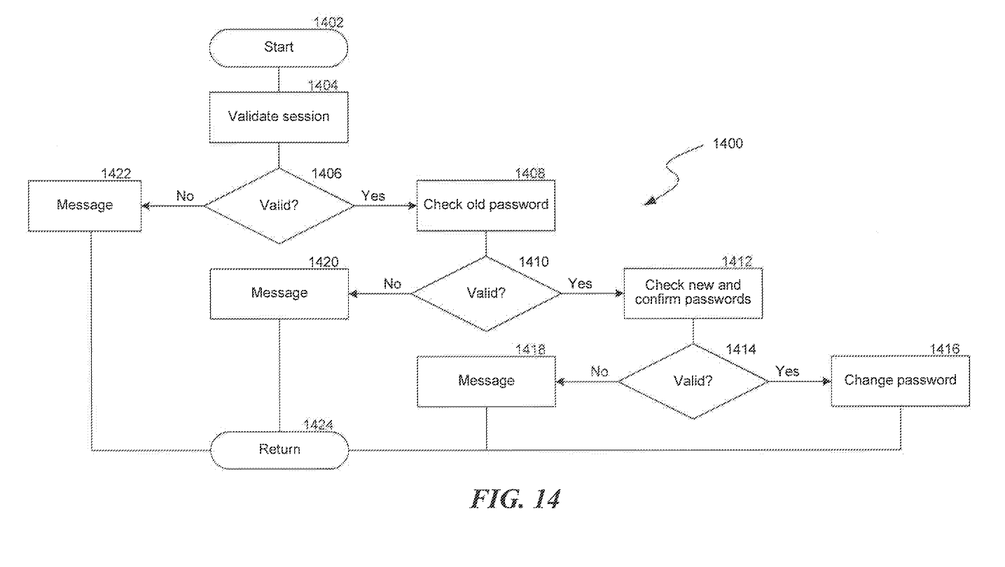

FIG. 14 is a flow diagram illustrating a routine 1400 for changing a user's password. The routine begins at block 1402. At block 1404 the monitoring device's session is validated. If the session is valid when checked at block 1406, the routine checks the old password at block 1408. If the old password is valid at block 1410, the routine checks the new password (entered twice to confirm) at block 1412. If the new passwords are valid at block 1414, the routine changes the password at block 1416 and returns at block 1424. If the routine determines at block 1406 that the session is not valid, a message is produced at block 1422 and the routine returns at block 1424. If the routine determines at block 1410 that the old password is not valid, a message is produced at block 1420 and the routine returns at block 1424. If the routine determines the new password (entered twice to confirm) is not valid at block 1414, a message is produced at block 1418 and the routine returns at block 1424.

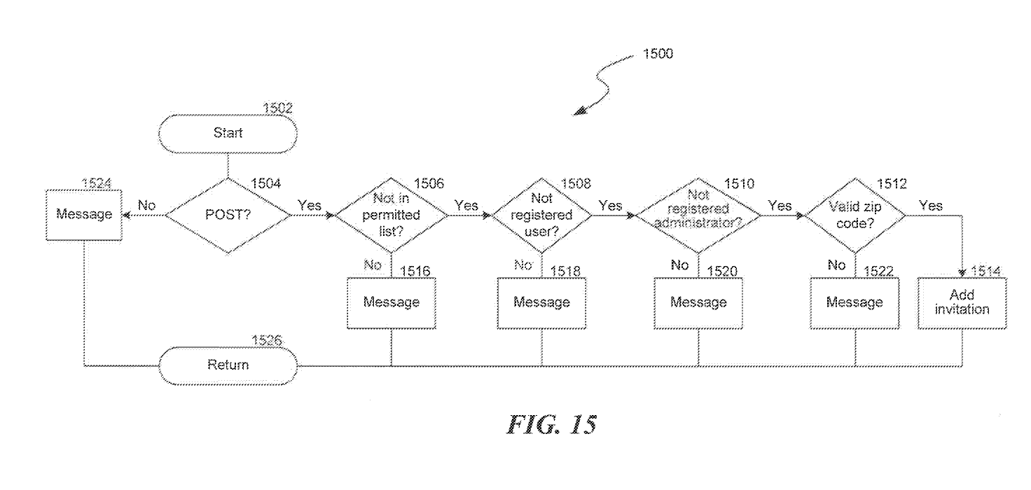

FIG. 15 is a flow diagram illustrating a routine 1500 for processing user requests for invitations to participate. The routine begins at block 1502. At block 1504 the server may receive a post requesting an invite. If no post is received a message is displayed at block 1524 and the routine returns at block 1526. If a post is received at block 1504, the routine proceeds to block 1506 where the routine determines if the requesting user's e-mail address does not already exists in the list of permitted users (those offered invitations). If the routine determines that the requesting user's e-mail is already in the permitted list, the routine proceeds to block 1516 where a message is displayed, and the routine returns at block 1526. If the routine determines that the requesting user's e-mail is not in the permitted list, the routine proceeds to block 1508. At block 1508 the routine determines if the requesting user is not already a registered user. If the requesting user is already also a registered user, the routine displays a message at block 1518 and the routine returns at block 1526. If the routine determines at block 1508 that the requesting user is not already a registered user, the routine proceeds to block 1510. At block 1510, the routine determines if the requesting user is not already a registered administrator. If the requesting user is a registered administrator, the routine displays a message at block 1520 and the routine returns at block 1526. If the routine determines that the requesting user is not a registered administrator at block 1510, the routine continues to block 1512 where it determines if the requesting user supplied a valid zip code with his/her invitation request. If the zip code is determined not to be valid, a message is displayed at block 1522 and the routine returns at block 1526. If the zip code is determined to be valid at block 1512, the routine proceeds to block 1514 where it adds an invitation for the requesting user and the routine returns at block 1526.

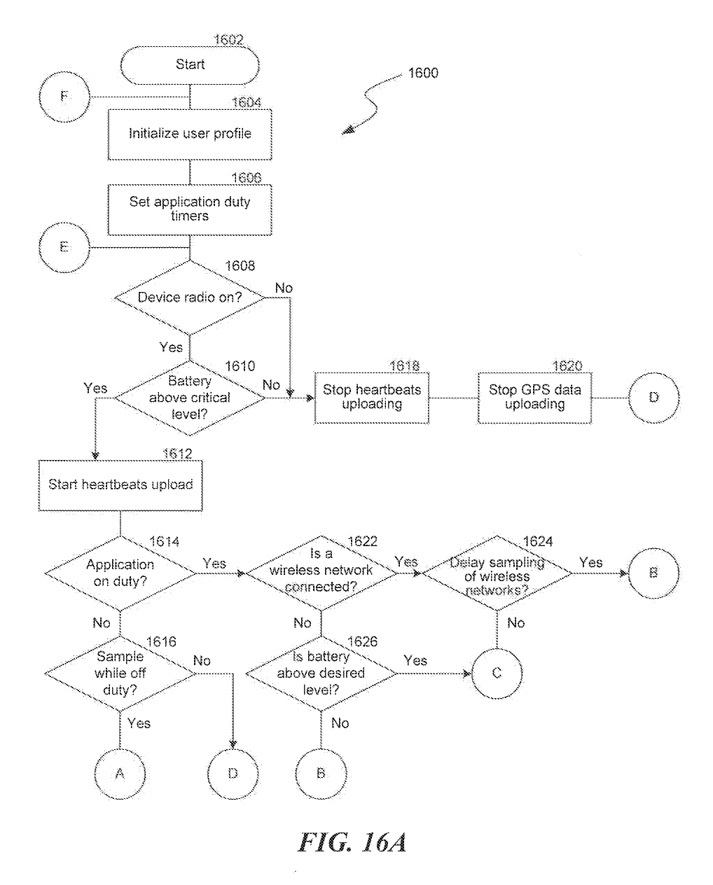

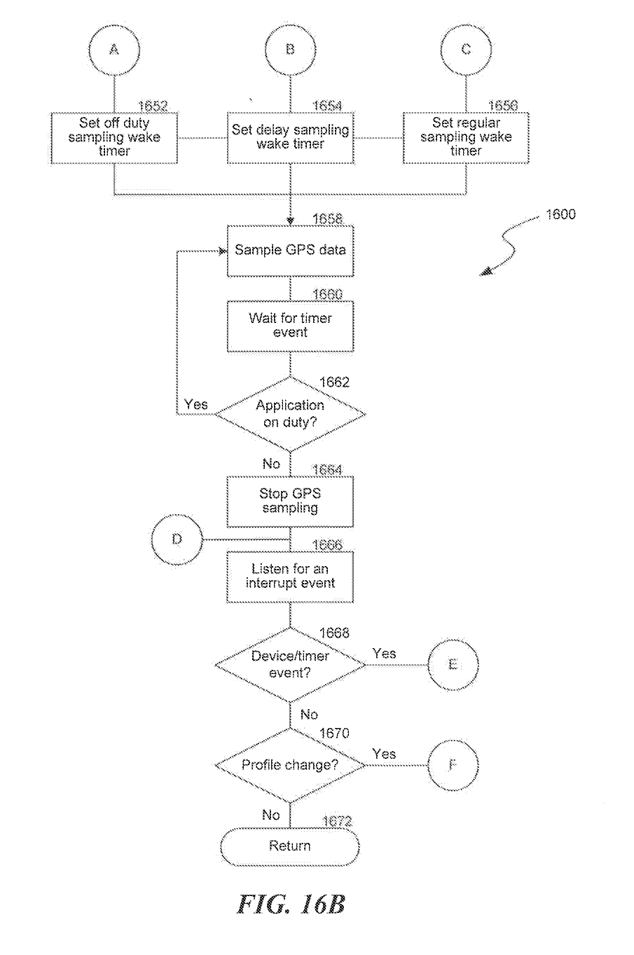

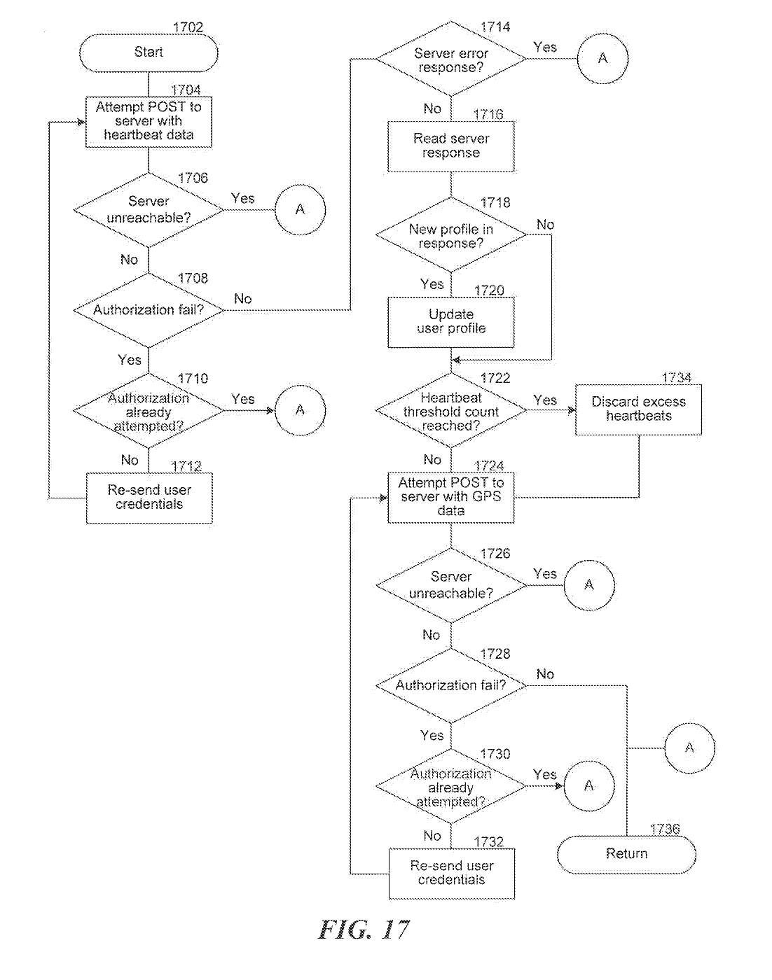

FIG. 16A is a flow diagram illustrating part of a routine 1600 governing the behavior of a monitoring device. The routine begins at block 1602. The routine proceeds to block 1604 (which is also initiated as reference point F) where the “user profile” (monitoring device settings) is initialized. The routine proceeds to block 1606 where the application duty timers are set. At block 1608 (which is also initiated as reference point E) the routine checks to determine if the device's radio (e.g., cellular connection) is turned on. If it is not turned on, the routine continues to block 1618 where the routine stops uploading diagnostic information (“heartbeats”), and then block 1620 where the routine stops uploading collected data (“GPS data”), and proceeds to reference point D. If at block 1608 the routine determines that the monitoring device's radio is turned on, the routine proceeds to block 1610 where it checks to see if the device's battery is above a critical level (e.g., 5%). If the battery is not above such a critical level, the routine proceeds to block 1618 and onwards to reference point D. If the device's battery is above a critical level, the routine proceeds to block 1612 where it starts uploading heartbeats (the subroutine for which is described in FIG. 17). After block 1612, the routine proceeds to block 1614 where it checks to determine if the application is “on duty.” If the application is not on duty, the routine proceeds to block 1616 where it checks to see if it is set to sample while off duty. If yes, the routine proceeds to reference point A. If no, the application proceeds to reference point D. If at block 1614 the routine determines the application is on duty, it proceeds to block 1622 where it determines if the monitoring device is connected to a wireless (e.g., Wi-Fi) network. If the device is not connected to such a network, the routine progresses to block 1626 where it determines if the device's battery is above a desired level (e.g., a low battery threshold). If the device's battery is not above such a threshold, the routine progresses to reference point B. If the device's battery is above such a threshold, the routine progresses to reference point C. If at block 1622 the routine determines that the device is connected to a wireless network, the routine progresses to block 1624, where the routine checks to determine if a sampling delay has been set for the condition where the device is connected to a wireless network. If no such delay has been set, the routine progresses reference point C. If a delay is set, the routine proceeds to reference point B.

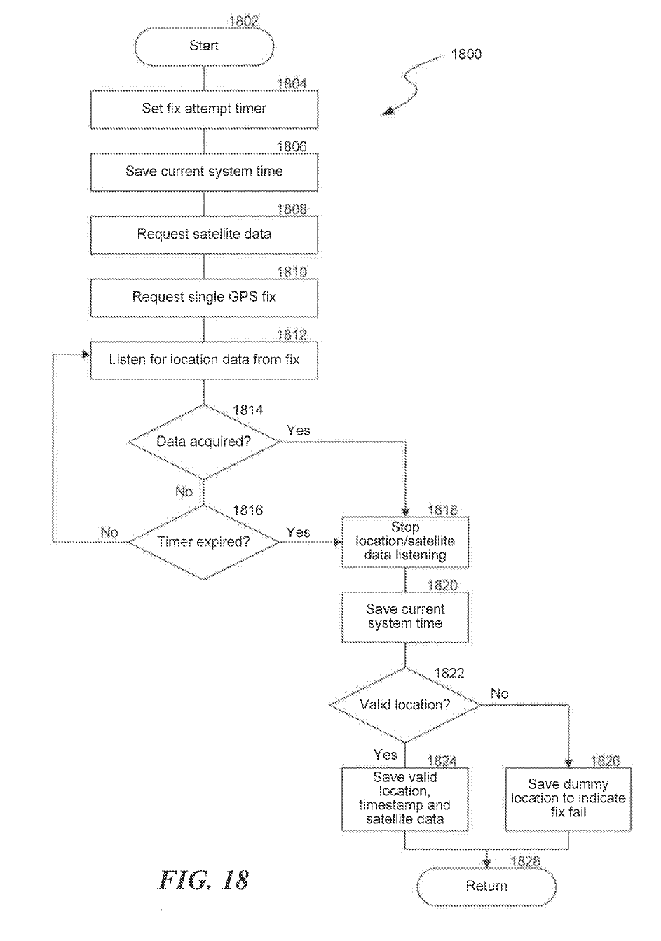

FIG. 16B is a flow diagram illustrating part of routine 1600 governing the behavior of a monitoring device. The flow diagram begins at reference points A, B, and C. At reference point A the routine begins at block 1652 where the routine sets an off duty sampling wake timer and then progresses to block 1658. At reference point B the routine begins at block 1654 where the routine sets a delay sampling wake timer and then progresses to block 1658. At reference point C the routine sets a regular sampling wake timer and then progresses to block 1658. At block 1658 the routine begins sampling geographic location (“GPS”) data, (the subroutine for which is described in FIG. 18). The routine continues to block 1660 where it waits for a timer event. After the timer event occurs, the routine proceeds to block 1662 where the routine checks to see if the application is on duty. When an application is on duty, it may collect geographic location information much more frequently than if the application is off duty. If the application is on duty, the routine returns to block 1658. If the application is not on duty, the routine continues to block 1664 where it stops sampling geographic location (“GPS”) data. The routine continues to block 1666 (which is also reference point D) where it waits for an interrupt event. If a device or timer event occurs at block 1668, the routine continues to reference point E. If such an event does not occur, the routine proceeds to block 1670 where the routine determines if the profile (“application settings”) has changed. If they have changed, the routine proceeds to reference point F. If the settings have not changed, the routine returns at block 1672.

FIG. 17 is a flow diagram illustrating a routine 1700 for uploading diagnostic information (“heartbeats”) and GPS data from a monitoring device. The routine begins at block 1702. The routine attempts to post to the server with heartbeat data at block 1704. If the server is unreachable at block 1706, the routine proceeds with reference point A. If the server is not unreachable at block 1706, the routine proceeds to check to see if authorization to post fails at block 1708. If the authorization does fail, the routine proceeds to block 1710 to determine if the authorization was already attempted. If it was, the routine proceeds with reference point A. If the authorization was not already attempted, the routine continues to block 1712 where it re-sends the user credentials to the server and returns to block 1704. If the authorization does not fail at block 1708, the routine proceeds to block 1714. At block 1714, the server may respond with an error. If it does, the routine proceeds with reference point A. If the server does not respond with an error, the routine proceeds to block 1716 where it reads the server's response. Next at block 1718, the routine determines if there is a new “profile” (settings) provided by the server in its response. If there is a new profile in the response, the routine updates the active profile on the monitoring device at block 1720 and proceeds to block 1722. If there is no new profile in the server's response at block 1718, the routine proceeds to block 1722. At block 1722 the routine checks if the heartbeat threshold count has been reached (a maximum number of permitted heartbeats to be sent simultaneously). If the heartbeat threshold count has been reached, the routine progresses to block 1734 and discards extraneous heartbeats. The routine then progresses to block 1724 and attempts to post collected geographic location (“GPS”) data to the central server. If at block 1722 the heartbeat threshold has not been reached, the routine also progresses to block 1724 and attempts to post collected geographic location (“GPS”) data to the central server. After block 1724 the routine progresses to block 1726 and checks if the central server is unreachable. If the server is unreachable, the routine proceeds to reference point A. If the server is not unreachable at block 1726, the routine proceeds to block 1728 where it checks to see if authorization to post fails. If it does fail, the routine progresses to block 1730 and checks to see if authorization has already been attempted. If it has, the routine progresses to reference point A. If it has not, the routine proceeds to block 1732 where it re-sends the user credentials and returns to block 1724. If at block 1728 the authorization does not fail, the routine returns at block 1736.

FIG. 18 is a flow diagram illustrating a routine 1800 for sampling geographic location data using inputs from a GPS chipset. The routine begins at block 1802. At block 1804 the routine sets a fix attempt timer. At block 1806 the routine saves the current time from the monitoring device's clock. The routine then requests data on the satellites available for a geographic location fix at block 1808 (the “satellite data”) and requests the geographic location fix at block 1810. At block 1812 the routine begins listening for the geographic location data (fix) from the GPS chipset. At block 1814, if the data is not acquired the routine checks to see if the timer has expired at block 1816. If the timer has not expired, the routine continues listening for the data at block 1812. If the data is acquired at block 1814 or if the timer has expired at block 1816, the routine proceeds to block 1818 where it stops listening for geographic location and satellite data. The routine then saves the current monitoring device clock time at block 1820. At block 1822 the routine determines if the geographic location data received provides a valid geographic location. If the data is not valid, the routine saves a dummy geographic location to indicate a failed fix at block 1826 and returns at block 1828. If at block 1822 the geographic location data is determined to be valid, the routine saves the collected geographic location data, an associated timestamp from the monitoring device's clock, and the satellite data at block 1824 and returns at block 1828.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A computer-readable storage medium storing computer-executable instructions that, if executed, provide an application program interface, comprising:
receiving a query from a client, the query specifying at least a personal data parameter identifying a characteristic of users;
collecting data based at least on the specified parameters, the collected data previously stored in a database; and
returning to the client a summary of the collected data, wherein the summary is produced using at least a statistical analysis of the data and does not include data particularly identifying a user.

2. The computer-readable storage medium of claim 1, further comprising receiving a geographic location parameter identifying a geographic location.

3. The computer-readable storage medium of claim 1, further comprising identifying one or more advertisements for a user from whom geographic location data was received that satisfies the received geographic location parameter.

4. The computer-readable storage medium of claim 1, wherein the summary is a predictor of economic success for a product or service at the identified geographic location.

5. The computer-readable storage medium of claim 1, wherein the personal data identifies a demographic characteristic of users.

6. The computer-readable storage medium of claim 5, wherein the demographic characteristic is an income range.

7. The computer-readable storage medium of claim 1, further comprising returning the collected data in a displayable report.

8. The computer-readable storage medium of claim 7, wherein the displayable report includes a heat map.

9. The computer-readable storage medium of claim 7, wherein the displayable report includes a display of a prediction.

10. The computer-readable storage medium of claim 9, wherein the prediction is of a count of people who are likely to transit an identified impact zone.

11. The computer-readable storage medium of claim 9, wherein the prediction is of a frequency for at least one person to transit an identified impact zone.

12. The computer-readable storage medium of claim 9, wherein the prediction is of a personal data of people who are likely to transit an identified impact zone.

13. The computer-readable storage medium of claim 1, further comprising receiving geographic location data relating to multiple users wherein the geographic location data was dynamically determined by one or more mobile computing devices proximate to each of the multiple users and previously associated with the multiple users.

14. The computer-readable storage medium of claim 1, further comprising:
receiving an indication from a second user that the second user does not desire data relating to the second user to be shared with the client; and
preventing data relating to the second user from being included in the summary of the collected data.

15. The computer-readable storage medium of claim 1, wherein at least one personal data parameter is inferred.

16. A system, comprising:
one or more processors and storage devices;
a first component configured to receive and store geographic location data and personal data relating to multiple users wherein the geographic location data was dynamically determined by one or more mobile computing devices proximate to the multiple users and previously associated with the users;
a second component configured to collect previously stored data in a database based at least on the specified parameters
a third component configured to predict an economic success indicator based on the collected data.

17. The system of claim 16, wherein the success indicator is a traded financial instrument.

18. The system of claim 17, further comprising a fourth component configured to trade the financial instrument in a financial market exchange based on the predicted economic success indicator.
